(19) United States
(12) Patent Application Publication
(10) Pub. No.: US 2011/0074557 A1
(43) Pub. Date: Mar. 31, 2011

(54) DISPLAY DEVICE WITH ILLUMINATED INPUT/OUTPUT TERMINALS

(75) Inventor: Chun-Han Chiu, Luodong Township (TW)

(73) Assignee: HANNSTAR DISPLAY CORPORATION LTD., Taipei City (TW)

(21) Appl. No.: 12/695,688

(22) Filed: Jan. 28, 2010

(30) Foreign Application Priority Data
Sep. 25, 2009 (TW) 098132600

(51) Int. Cl. G05B 19/02; F21V 7/04

(52) U.S. Cl. 340/12.54; 362/611

(57) ABSTRACT

A display device is provided. The display device comprises a display unit having a rear side; an input/output unit disposed at the rear side of the display unit and having a plurality of input/output terminals; a back cover disposed at the rear side of the display unit and engaged with the input/output unit; a label unit disposed on the back cover and corresponding to the plurality of input/output terminals; and a lighting unit disposed at a side of the label unit.

### FIELD OF THE INVENTION

The present invention relates to a display device, and more particularly to a display device with illuminated input and output terminals.

### BACKGROUND OF THE INVENTION

Generally, the display device, such as an LCD TV or a plasma TV, not only includes a display panel but also includes input/output terminals at the rear side for transmitting signals. When in use, signal cables are connected to the input/output terminals to achieve the object of inputting and outputting signals.

In general, the indoor lighting apparatus is disposed in the center of the ceiling. However, the display device is usually placed at the edge or corner of the indoor space adjacent to the wall. That is, for the indoor lighting apparatus, the input/output terminals at the rear side of the display device are against the light. Hence, when the user needs to plug the transmission lines into the corresponding input/output terminals, the light at the rear side of the display device is too dim for him to clearly identify the positions and colors of the input/output terminals as well as the corresponding symbols therebeside. This causes an inconvenience for the user. Accordingly, when the user needs to plug the transmission lines, he needs to move the display device away from the wall so that the input/output terminals can obtain more light to facilitate plugging. Besides, since the size of the display device is getting larger and the thickness thereof is getting thinner, the depth of the furniture for placing the display device tends to be smaller for saving space. Therefore, the space for the display device to move is getting smaller, so that it is harder to move the display device to the position where the input/output terminals can obtain more light.

In order to overcome the drawbacks in the prior art, a display device with illuminated input/output terminals is provided. The particular designs in the present invention not only solve the problems described above, but also are easy to be implemented. Thus, the present invention has the utility for the industry.

### SUMMARY OF THE INVENTION

In accordance with an aspect of the present invention, a display device is provided. The display device comprises a display unit having a rear side; an input/output unit disposed at the rear side of the display unit and having a plurality of input/output terminals; a back cover disposed at the rear side of the display unit and engaged with the input/output unit; a label unit disposed on the back cover and corresponding to the plurality of input/output terminals; and a lighting unit disposed at a side of the label unit.

Preferably, the display unit is one selected from a group consisting of a CRT display, an LCD, an OLED display and a PDP.

Preferably, the lighting unit further comprises a light source disposed at the side of the label unit; and a flexible printed circuit board electrically connected to the light source.

Preferably, the flexible printed circuit board further comprises a wireless signal receiver receiving a signal for controlling a turn-on/turn-off of the light source.

Preferably, the label unit has a plurality of marking symbols corresponding to the plurality of input/output terminals.

Preferably, the display device further comprises a remote control having a button or a touch pad for turning on/turning off the lighting unit.

Preferably, the display device further comprises a button or a touch pad electrically connected to the lighting unit and controlling a turn-on/turn-off of the lighting unit.

In accordance with another aspect of the present invention, a display device is provided. The display device comprises a display unit having a rear side; a plurality of input/output terminals disposed at the rear side of the display unit; a back cover disposed at the rear side of the display unit and having an opening for exposing the plurality of input/output terminals; a transparent plate disposed on the back cover and having a first and a second sides; a printing layer disposed at the first side of the transparent plate and having a plurality of marking symbols corresponding to the plurality of input/output terminals; and a lighting unit disposed at the second side of the transparent plate.

Preferably, the display unit is one selected from a group consisting of a CRT display, an LCD, an OLED display and a PDP.

Preferably, the lighting unit further comprises a light source disposed at the second side of the transparent plate; and a flexible printed circuit board electrically connected to the light source.

Preferably, the flexible printed circuit board further comprises a wireless signal receiver receiving a signal for controlling a turn-on/turn-off of the light source.

Preferably, the transparent plate has a recess for containing the light source.

Preferably, the transparent plate is a light guide.

Preferably, the display device further comprises a remote control having a button or a touch pad for turning on/turning off the lighting unit.

Preferably, the display device further comprises a button or a touch pad electrically connected to the lighting unit and controlling a turn-on/turn-off of the lighting unit.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1a shows the rear side of the display device without the label unit according to a preferred embodiment of the present invention;

FIG. 1b shows the rear side of the display device with the label unit according to a preferred embodiment of the present invention;

FIG. 2 shows the rear side of the display unit in the present invention;

FIG. 3a shows the label unit and the lighting unit according to a preferred embodiment of the present invention;

FIG. 3b shows the label unit and the lighting unit according to another preferred embodiment of the present invention;

FIG. 4a is a circuit diagram of the lighting unit in the present invention; and

FIG. 4b is another circuit diagram of the lighting unit in the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

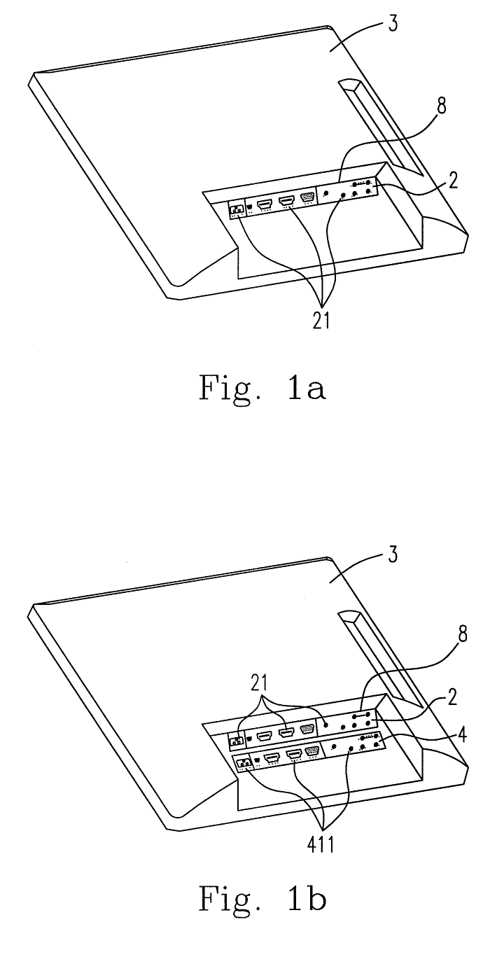

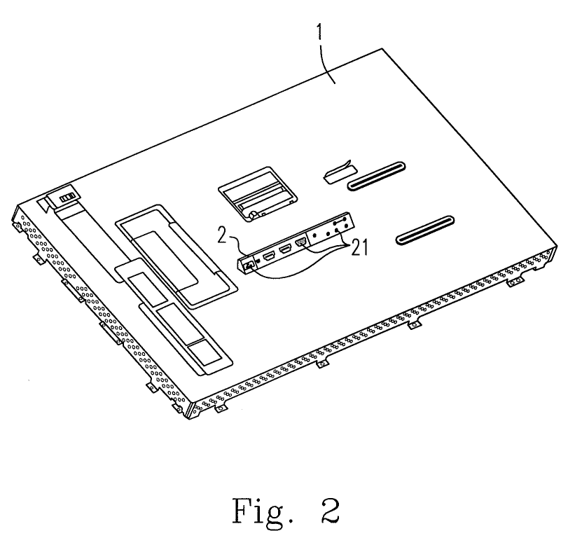

Please refer to FIGS. 1a, 1b and 2. FIG. 1a shows the rear side of the display device without the label unit according to a preferred embodiment of the present invention, FIG. 1b shows the rear side of the display device with the label unit according to a preferred embodiment of the present invention, and FIG. 2 shows the rear side of the display unit in the present invention. As shown in FIGS. 1a, 1b and 2, the display device of the present invention includes a display unit 1, an input/output unit 2, a back cover 3, a label unit 4 and a lighting unit (not shown). The input/output unit 2 is disposed at the rear side of the display unit 1 and includes a plurality of input/output terminals 21. The back cover 3 is disposed at the rear side of the display unit 1 and engaged with the input/output unit 2. The label unit 4 is disposed on the back cover 3 and corresponding to the input/output terminals 21 of the input/output unit 2. The lighting unit is disposed at a side of the label unit 4 and irradiates light for lighting up the label unit 4. Accordingly, when the environment is dark, the lighting unit can irradiate light to light up the label unit 4. A plurality of marking symbols 411 on the label unit 4 are corresponding to the plurality of input/output terminals 21 of the input/output unit 2, so that the user can clearly identify the respective positions of the input/output terminals 21.

The display unit 1 is used for displaying images, which can be a CRT display, an LCD, an OLED display or a PDP, but is not limited thereto. The back cover 3 is engaged with the input/output unit 2, and has an opening 8 for exposing the input/output terminals 21.

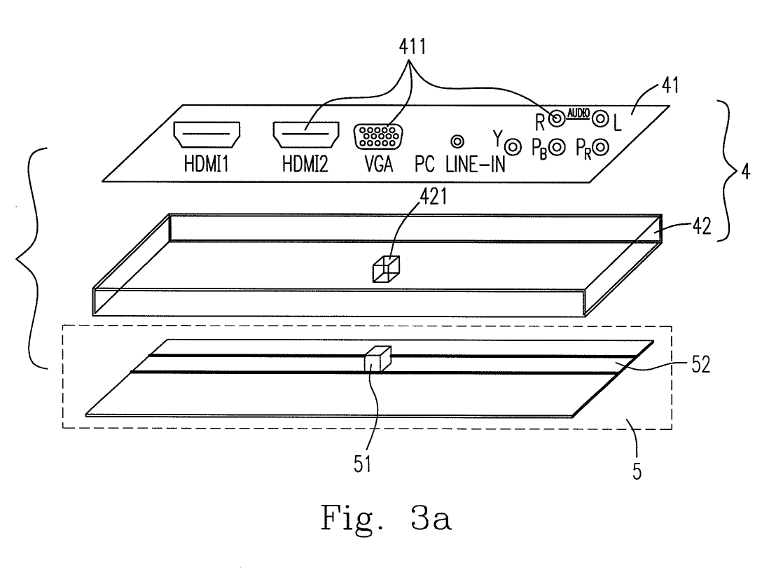

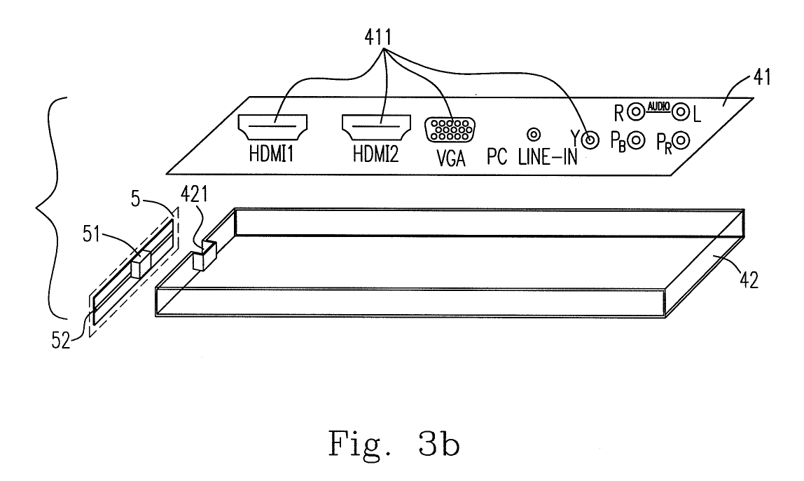

Please refer to FIGS. 3a and 3b. FIG. 3a shows the label unit and the lighting unit according to a preferred embodiment of the present invention, and FIG. 3b shows the label unit and the lighting unit according to another preferred embodiment of the present invention. The label unit 4 further includes a transparent plate 42 disposed on the label unit 4 of the back cover 3, and a printing layer 41 disposed at a side of the transparent plate 42 and having the plurality of marking symbols 411 for being corresponding to the plurality of input/output terminals 21. The transparent plate 42 can be a light guide plate for providing uniform light to the label unit 4. The lighting unit 5 further includes a light source 51 disposed at a side of the label unit 4, and a flexible circuit board 52 electrically connected to the light source 51. The light source 51 can be an ordinary light bulb, an LED lamp, a halogen lamp, etc., but is not limited thereto. The transparent plate 42 further includes a recess 421 for containing the light source 51. The recess 421 can be disposed at a lower side or a lateral side of the transparent plate 42. When the lighting unit 5 is disposed at the lower side of the transparent plate 42, the recess 421 can contain the light source 51, as shown in FIG. 3a. When the lighting unit 5 is disposed at the lateral side of the transparent plate 42, the recess 421 can contain the light source 51, as shown in FIG. 3b. Besides, when the lighting unit 5 is disposed at the lateral side of the transparent plate 42, a containing space (not shown) can be disposed on the flexible circuit board 52 for containing the light source 51, instead of disposing the recess 421 on the transparent plate 42.

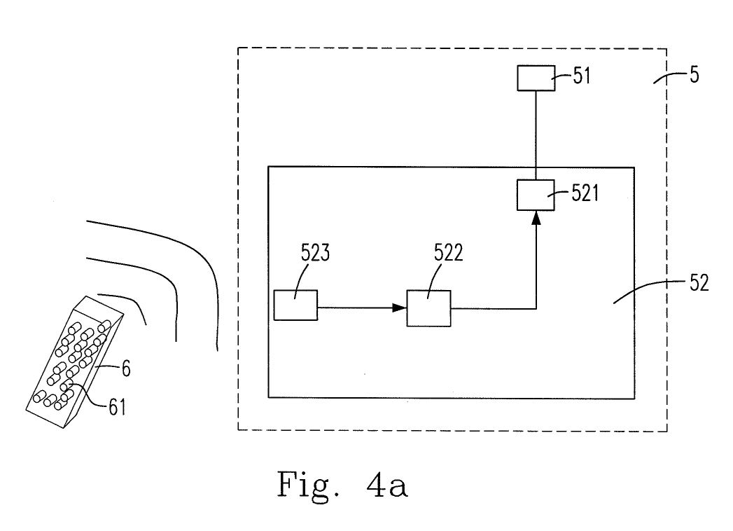

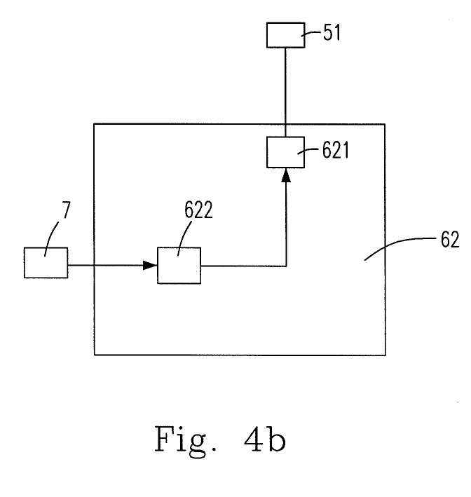

Please refer to FIG. 4a, which is a circuit diagram of the lighting unit in the present invention. The flexible circuit board 52 includes a microprocessor 522, a wireless signal receiver 523 and an LED signal terminal 521. The wireless signal receiver 523 is electrically connected to the microprocessor 522 and receives the signal for controlling the turn-on/turn-off of the light source 51. When the wireless signal receiver 523 receives the signal sent by an external remote control 6, the light source 51 will be turned on/turned off. When the user needs to plug cables in the input/output terminals 21, he can press a button 61 or a touch pad (not shown) of the remote control 6 to turn on the light source 51 so as to proceed the connections between the input/output terminals 21 and the external devices. After the connections between the input/output terminals 21 and the external devices are completed, the user can press the button 61 again to turn off the light source 51. This will save the power. If the user forgets to press the button 61 again, the light source 51 will be automatically turned off after a period of time. The period of time can be 10 seconds, 30 seconds, 1 minute, etc., but is not limited thereto.

Please refer to FIG. 4b, which is another circuit diagram of the lighting unit in the present invention. The flexible circuit board 62 includes a microprocessor 622 and an LED signal terminal 621. The display device further includes a button 7 or a touch pad (not shown) electrically connected to the flexible circuit board 62 for controlling the turn-on/turn-off of the lighting unit 5. When the user needs to plug cables in the input/output terminals 21, he can press the button 7 to turn on the light source 51 so as to proceed the connections between the input/output terminals 21 and the external devices. After the connections between the input/output terminals 21 and the external devices are completed, the user can press the button 7 again to turn off the light source 51. This will save the power. If the user forgets to press the button 7 again, the light source 51 will be automatically turned off after a period of time. The period of time can be 10 seconds, 30 seconds, 1 minute, etc., but is not limited thereto.

In conclusion, the lighting unit 4 of the display device in the present invention can allow the input/output terminals 21 of the input/output unit 2 to be lit up via the label unit 4. Even if the input/output terminals 21 are located in a dark environment, the respective positions of the input/output terminals 21 and the corresponding marking symbols 411 therebeside can be clearly identified. For the large-sized display device, the present invention is quite convenient and practical. Accordingly, the present invention can effectively solve the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A display device, comprising:
a display unit having a rear side;
an input/output unit disposed at the rear side of the display unit and having a plurality of input/output terminals;
a back cover disposed at the rear side of the display unit and engaged with the input/output unit;
a label unit disposed on the back cover and corresponding to the plurality of input/output terminals; and
a lighting unit disposed at a side of the label unit.

2. A display device as claimed in claim 1, wherein the display unit is one selected from a group consisting of a CRT display, an LCD, an OLED display and a PDP.

3. A display device as claimed in claim 1, wherein the lighting unit further comprises:
a light source disposed at the side of the label unit; and
a flexible printed circuit board electrically connected to the light source.

4. A display device as claimed in claim 3, wherein the flexible printed circuit board further comprises a wireless signal receiver receiving a signal for controlling a turn-on/turn-off of the light source.

5. A display device as claimed in claim 1, wherein the label unit has a plurality of marking symbols corresponding to the plurality of input/output terminals.

6. A display device as claimed in claim 1, further comprising a remote control having a button or a touch pad for turning on/turning off the lighting unit.

7. A display device as claimed in claim 1, further comprising a button or a touch pad electrically connected to the lighting unit and controlling a turn-on/turn-off of the lighting unit.

8. A display device, comprising:
a display unit having a rear side;
a plurality of input/output terminals disposed at the rear side of the display unit;
a back cover disposed at the rear side of the display unit and having an opening for exposing the plurality of input/output terminals;
a transparent plate disposed on the back cover and having a first and a second sides;
a printing layer disposed at the first side of the transparent plate and having a plurality of marking symbols corresponding to the plurality of input/output terminals; and
a lighting unit disposed at the second side of the transparent plate.

9. A display device as claimed in claim 8, wherein the display unit is one selected from a group consisting of a CRT display, an LCD, an OLED display and a PDP.

10. A display device as claimed in claim 8, wherein the lighting unit further comprises:
a light source disposed at the second side of the transparent plate; and
a flexible printed circuit board electrically connected to the light source.

11. A display device as claimed in claim 10, wherein the flexible printed circuit board further comprises a wireless signal receiver receiving a signal for controlling a turn-on/turn-off of the light source.

12. A display device as claimed in claim 10, wherein the transparent plate has a recess for containing the light source.

13. A display device as claimed in claim 8, wherein the transparent plate is a light guide.

14. A display device as claimed in claim 8, further comprising a remote control having a button or a touch pad for turning on/turning off the lighting unit.

15. A display device as claimed in claim 8, further comprising a button or a touch pad electrically connected to the lighting unit and controlling a turn-on/turn-off of the lighting unit.
